(19) United States
(12) Patent Application Publication
(10) Pub. No.: US 2014/0349064 A1
(43) Pub. Date: Nov. 27, 2014

(54) WINDOW STRUCTURE FOR DISPLAY DEVICE AND DISPLAY DEVICE HAVING THE SAME

(71) Applicant: Samsung Display Co., Ltd., Yongin-City (KR)

(72) Inventors: Kyung-Woo Han, Yongin-City (KR); Kyu-Young Kim, Yongin-City (KR)

(73) Assignee: Samsung Display Co., Ltd., Yongin-City (KR)

(21) Appl. No.: 14/134,792

(22) Filed: Dec. 19, 2013

(30) Foreign Application Priority Data
May 27, 2013 (KR) 10-2013-0059792

(51) Int. Cl. B32B 5/12

(52) U.S. Cl. CPC B32B 5/12; B32B 2250/20; B32B 2250/02; B32B 2250/24; B32B 2260/023; B32B 2260/046; B32B 2307/584; B32B 2457/20; B32B 2250/04; B32B 2250/03
USPC 428/113

(57) ABSTRACT

Provided is a window structure. The window structure for a display device is formed by laminating a plurality of resin layers including fiber structures formed in a grid shape. A first grid array angle in a first direction of a first resin layer positioned at the upper side when viewed from a laminated direction of the plurality of resin layers is different from a second grid array angle in a first direction of a second resin layer positioned directly under the first resin layer.

### CLAIM PRIORITY

This application makes reference to, incorporates the same herein, and claims all benefits accruing under 35 U.S.C. §119 from an application earlier filed in the Korean Intellectual Property Office on 27 May 2013 and there duly assigned Serial No. 10-2013-0059792.

### BACKGROUND OF THE INVENTION

1. Field of the Invention

Embodiments of the present invention generally relate to a window structure for a display device and a display device having the same, and more particularly, to a window structure for a flexible display device and a flexible display device having the same.

2. Description of the Related Art

In general, various portable electronic devices such as a mobile phone, a personal digital assistant (PDA), and a portable DVD player (PDP) include display devices for displaying an image. Flat panel displays such as a liquid crystal display (LCD), an organic light emitting diode display (OLED), and an electrophoretic display (EPD), which have excellent space efficiency, are widely used as the display devices, and the flat panel display installed on the portable electronic device includes a window for protecting a display panel which is exposed outside.

In the related art, in order to manufacture a window for a display device, functional coating AR and AF was applied on a rigid glass material. The glass type window had scratch resistance having pencil hardness of 9H or more. However, the glass type window was not suitable for a flexible display device due to large stiffness.

Meanwhile, a flexible window having pencil hardness of 3H or more was manufactured by laminating a functional coating (AR, AF, etc.) and a hard coating (epoxy, polyurethanes, etc.) on a film type polyethylene terephthalate (PET) or a plastic processing material such as polyimide (PI). Such a film type window has a flexible property, but is vulnerable to a sharp tool such as a pen.

The above information disclosed in this Background section is only for enhancement of understanding of the background of the described technology and therefore it may contain information that does not form the prior art that is already known in this country to a person of ordinary skill in the art.

### SUMMARY OF THE INVENTION

The described technology has been made in an effort to provide a window structure for a display device which has strong resistance against scratching while being flexible, and a display device having the same.

An embodiment provides a window structure for a display device. The window structure includes a plurality of stacked resin layers that include a first resin layer including a fiber structure formed in a grid shape by extending a plurality of fibers in a first direction and by extending a plurality of fibers in a second direction crossing the first direction. The plurality of stacked resin layers may include a second resin layer including a fiber structure formed in a grid shape by extending a plurality of fibers in a third direction crossing each of the first and second directions and by extending a plurality of fibers in a fourth direction crossing the third direction.

An angle between the first direction and the second direction and an angle between the third direction and the fourth direction may be equal to each other.

The first and second directions may be perpendicular to each other and the third and fourth directions may be perpendicular to each other.

The plurality of stacked resin layers may include odd resin layers and even resin layers that are alternatively stacked on the first and second resin layers. The second resin layer may be interposed between the first resin layer and the odd and even resin layers. Each odd resin layer may include a fiber structure formed in a grid shape by extending a plurality of fibers in the first direction and by extending a plurality of fibers in the second direction. Each even resin layer may include a fiber structure formed in a grid shape by extending a plurality of fibers in the third direction and by extending a plurality of fibers in the fourth direction.

The plurality of stacked resin layers may include a third through n-th resin layers that are stacked on the first and second resin layers, where n is a natural number and n is equal to or greater than 3. i-th resin layer may include a fiber structure formed in a grid shape by extending a plurality of fibers in one direction and by extending a plurality of fibers in another direction crossing the one direction, where i is a natural number selected from 3 to n. An angle between the one direction and the first direction is i−1 times of an angle between the third direction and the first direction.

Alternatively, the plurality of stacked resin layers may include a third through n-th resin layers that are stacked on the first and second resin layers, wherein n is a natural number and n is equal to or greater than 3. i-th resin layer includes a fiber structure formed in a grid shape by extending a plurality of fibers in one direction and extending a plurality of fibers in another direction crossing the one direction, wherein i is a natural number selected from 3 to n. An angle between the one direction and the first direction is randomly selected.

In this case, the fiber structure may include at least one of a transparent glass fiber, a metal fiber, a polymer fiber, an aramid fiber, and an ester fiber.

In this case, the resin layer may be made of an elastomer, epoxy, or polymer-based resin.

In this case, adhesive layers for coupling the adjacent resin layers with each other among the plurality of resin layers may be interposed among the plurality of resin layers.

Meanwhile, the plurality of resin layers may be formed in a single film shape which is formed by extrusion.

According to the embodiment, a window structure which has strong resistance against scratching while being flexible is provided.

Another exemplary embodiment provides a display device including a display unit displaying an image and a window structure including a plurality of stacked resin layers formed at a same side of the display unit. The plurality of resin layers may include a first resin layer including a fiber structure formed in a grid shape by extending a plurality of fibers in a first direction and by extending a plurality of fibers in a second direction crossing the first direction and a second resin layer including a fiber structure formed in a grid shape by extending a plurality of fibers in a third direction crossing the first and second directions and by extending a plurality of fibers in a fourth direction crossing the third direction.

An angle between the first direction and the second direction and an angle between the third direction and the fourth direction may be equal to each other.

The first and second directions may be perpendicular to each other and the third and fourth directions may be perpendicular to each other.

The plurality of stacked resin layers may include odd resin layers and even resin layers that are alternatively stacked on the first and second resin layers. The second resin layer may be interposed between the first resin layer and the odd and even resin layers. Each odd layer may include a fiber structure formed in a grid shape by extending a plurality of fibers in the first direction and by extending a plurality of fibers in the second direction. Each even layer may include a fiber structure formed in a grid shape by extending a plurality of fibers in the third direction and by extending a plurality of fibers in the fourth direction.

The plurality of stacked resin layers may include a third through n-th resin layers that are stacked on the first and second resin layers, where n is a natural number and n is equal to or greater than 3. i-th resin layer may include a fiber structure formed in a grid shape by extending a plurality of fibers in one direction and by extending a plurality of fibers in another direction crossing the one direction, where i is a natural number selected from 3 to n. An angle between the one direction and the first direction may be i−1 times of an angle between the third direction and the first direction.

Alternatively, the plurality of stacked resin layers may include a third through n-th resin layers that are stacked on the first and second resin layers, wherein n is a natural number and n is equal to or greater than 3. i-th resin layer may include a fiber structure formed in a grid shape by extending a plurality of fibers in one direction and extending a plurality of fibers in another direction crossing the one direction, wherein i is a natural number selected from 3 to n. An angle between the one direction and the first direction is randomly selected.

In this case, the fiber structure may include at least one of a transparent glass fiber, a metal fiber, a polymer fiber, an aramid fiber, and an ester fiber.

In this case, the resin layer may be made of an elastomer, epoxy, or polymer-based resin.

In this case, adhesive layers for coupling the adjacent resin layers with each other among the plurality of resin layers may be interposed among the plurality of resin layers.

Meanwhile, the plurality of resin layers may be formed in a single film shape which is formed by extrusion.

According to the embodiment, a display device including a window structure which has strong resistance against scratching while being flexible is provided.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a cross-sectional view illustrating a window structure constructed as a first embodiment according to the principles of the present invention;

FIG. 2 is a plan view illustrating a grid structure of a first resin layer of the window structure according to the first embodiment;

FIG. 3 is a plan view illustrating a grid structure of a second resin layer of the window structure according to the first embodiment;

FIG. 4 is a cross-sectional view illustrating a window structure constructed as a second embodiment according to the principles of the present invention;

FIG. 5 is a diagram illustrating an angle between grid array angles of adjacent resin layers of the window structure according to the second embodiment;

FIG. 6 is a cross-sectional view illustrating a window structure constructed as a third embodiment according to the principles of the present invention;

FIG. 7 is a diagram illustrating an angle between grid array angles of adjacent resin layers of the window structure according to the third embodiment; and

FIG. 8 is a cross-sectional view illustrating a window structure constructed as a fourth embodiment according to the principles of the present invention.

### DETAILED DESCRIPTION OF THE INVENTION

The exemplary embodiment may be variously modified and may have various aspects, and specific exemplary embodiments are exemplified in the accompanying drawings and will be described in detail in the specification. However, the present invention is not limited to the specific exemplary embodiments, and it is understood that all modifications, equivalents, and replacements are included in the spirit and scope of the present invention.

Like reference numerals are used for like elements when describing the drawings. In the accompanying drawings, sizes of structures are enlarged for clarity. Terms such as ‘first’, ‘second’, etc., can be used to describe various elements, but the elements are not construed as being limited to the terms. The terms are only used to differentiate one element from other elements. For example, the first element may be named the second element without departing from the scope of the present disclosure and similarly, the second element may also be named the first element. A singular expression includes plural expressions as long as the expression does not have apparently different contextual meaning.

In this specification, terms such as “comprise”, “include”, or “have” are used to designate presence of features, figures, steps, operations, elements, parts, or combinations thereof, which are described in the specification, and it should be understood that presence or addition possibilities of one or more other features or figures, steps, operations, elements, parts, or combinations thereof are not excluded in advance. It will be understood that when an element such as a layer, film, region, or substrate is referred to as being “on” another element, it can be “directly on” the other element or intervening elements may also be present. On the contrary, it will be understood that when an element such as a layer, film, region, or substrate is referred to as being “under” another element, it can be directly under the other element or intervening elements may also be present.

The exemplary embodiment will be described more fully hereinafter with reference to the accompanying drawings, in which exemplary embodiments of the invention are shown.

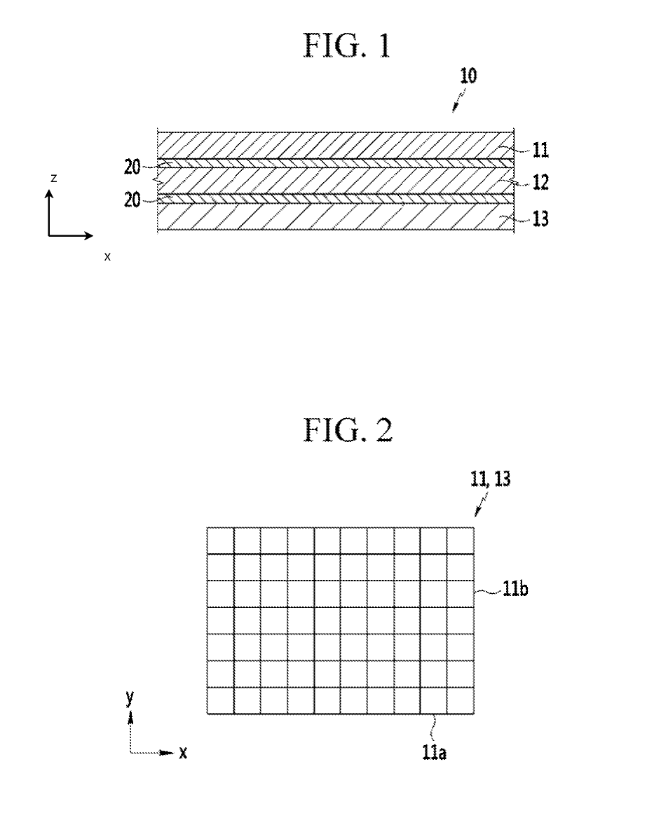

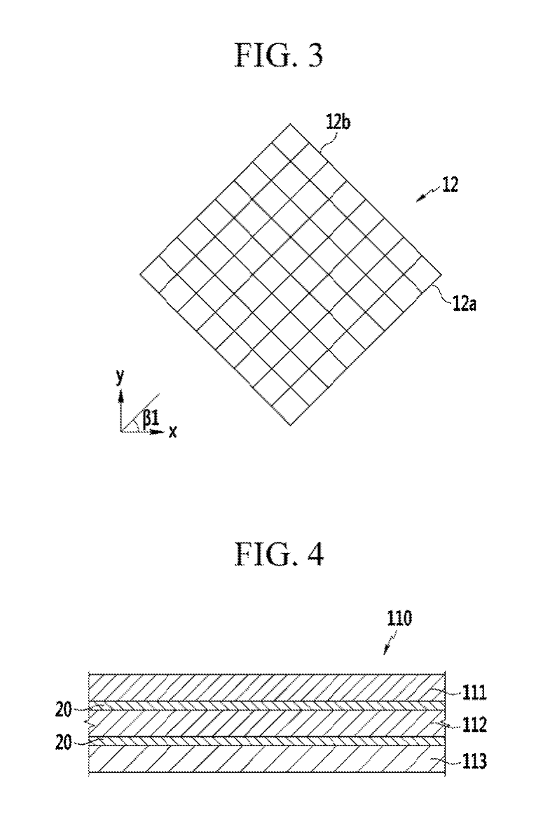

FIG. 1 is a cross-sectional view illustrating a window structure constructed as a first embodiment according to the principles of the present invention. FIG. 2 is a plan view illustrating a grid structure of a first resin layer of the window structure according to the first embodiment. FIG. 3 is a plan view illustrating a grid structure of a second resin layer of the window structure according to the first embodiment.

Referring to FIG. 1, a window structure 10 for a display device (hereinafter, referred to as a “window structure”) according to a first embodiment is positioned on a display panel of a display device such as an organic light emitting diode display.

The window structure 10 according to the embodiment may be formed by laminating a plurality of resin layers having a fiber structure. FIG. 1 exemplifies a structure in which three resin layers are laminated, but the number of resin layers may be three or more.

Hereinafter, when the window structure according to the embodiment is described with reference to the drawings, the plurality of resin layers will be described by defining a resin layer positioned at the upper side as a first resin layer 11, a resin layer positioned below the first resin layer as a second resin layer 12, a resin layer positioned below the second resin layer as a third resin layer 13, . . . , and a resin layer positioned at a n-th position as an n-th resin layer, from an upper side to a lower side in sequence, when viewed from a laminated direction (−z axis) of the plurality of resin layers in FIG. 1. In this case, in the first embodiment, for convenience of description, the plurality of resin layers is exemplified as the three resin layers 11, 12, and 13.

The plurality of resin layers 11, 12, and 13 may be made of an elastomer, epoxy, or polymer-based resin, but a kind of resin layer which is capable of forming the window structure is not limited thereto.

Meanwhile, an adhesive layer 20 for coupling adjacent resin layers among the plurality of resin layers 11, 12, and 13 is interposed between the plurality of resin layers 11, 12, and 13.

The window structure 10 including the plurality of resin layers 11, 12, and 13 may be manufactured by forming each resin layer by an extruding method after positioning a fiber structure on a resin material for forming the resin layer, coating an adhesive on each resin layer, and then laminating another resin layer on the resin layer coated with the adhesive.

Each resin layer of the window structure 10 manufactured as described above may have the same mechanical and physical characteristics in each layer.

Meanwhile, as the adhesive for adhering the plurality of resin layers 11, 12, and 13, a resin type adhesive may be used, and for example, a transparent adhesive having a small thickness of 14 microns or less may be used. As such, the adhesive layer 20 is formed between the plurality of resin layers 11, 12, and 13, and as a result, the window structure 10 according to the first embodiment may have a strong shock absorption property.

Meanwhile, according to the embodiment, a grid-shaped fiber structure may be positioned in each of the plurality of resin layers 11, 12, and 13. In this case, the fiber structure may include at least one of a transparent glass fiber, a metal fiber, a polymer fiber, an aramid fiber, and an ester fiber, but a kind of fiber structure is not limited thereto.

In this case, referring to FIG. 2, the grid-shaped fiber structure positioned in the first resin layer 11 may include a first fiber 11a extending in a first direction (x axis) in the first resin layer, and a second fiber 11b extending in a second direction (y-axis) which is vertical to the first direction. Further, referring to FIG. 3, the grid-shaped fiber structure positioned in the second resin layer 12 may include a first fiber 12a extending to be inclined at a predetermined angle in the first direction (x axis) in the second resin layer 12, and a second fiber 12b extending in a vertical direction to the first fiber 12a.

Alternatively, the first fiber 11a and the second fiber 11b may not be perpendicular to each other, and the first fiber 12a and the second fiber 12b may not be perpendicular to each other. An angle between the direction along which the first fiber 11a of the first resin layer 11 extends and the direction along which the second fiber 11b of the first resin layer 11 may be equal to an angle between the direction along which the first fiber 12a of the second resin layer 12 extends and the direction along which the second fiber 12b of the second resin layer 12 extends.

In this case, kinds and thicknesses of the first fibers 11a and 12a and the second fibers 11b and 12b, distances among a plurality of first fibers arranged to be parallel to each other and distances among a plurality of second fibers, arranged angles, and the like may be selected by considering hardness and characteristics of the resin layers forming the manufactured window structure.

Meanwhile, in this specification, an “n-th grid array angle” of an n-th resin layer means an angle at which the first fiber 11a extended in a horizontal direction of a fiber structure forming a grid of the n-th resin layer is inclined in a first direction, that is, an x axis.

In this case, according to the first embodiment, when viewed from the laminated direction (−z axis) of the plurality of resin layers, a first grid array angle in the first direction (x-axial direction in FIG. 1) of the first resin layer 11 may be different from a second grid array angle in the first direction of the second resin layer 12 positioned directly under the first resin layer 11. For example, in the first embodiment, the first grid array angle of the first resin layer 11 in FIG. 2 may be 0 degree, and the second grid array angle of the second resin layer 12 in FIG. 3 may be 45 degrees.

Further, according to the first embodiment, the grid array angles in the first directions of odd numbered resin layers in a lower direction from the upper side, that is, the first resin layer 11 and the third resin layer 13 may be formed to be equal to the first grid array angle, that is, 0 degree, and the grid array angle in the first direction of an even numbered resin layer from the upper side, that is, the second resin layer 12 may be formed to be equal to the second grid array angle, that is, 45 degrees.

As a result, according to the first embodiment, an angle β1 between the grid array angle of the odd numbered resin layer and the grid array angle of the even numbered resin layer may be 45 degrees. However, the angle β1 may vary according to the first grid array angle and the second grid array angle.

Accordingly, the window structure 10 according to the first embodiment may be flexible and have strong hardness due to the fiber structure in which the odd numbered resin layers and the even numbered resin layers are alternately arranged at an interval of 45 degrees.

Therefore, the window structure 10 according to the first embodiment has a small thickness and is strong against a sharp material such as a pen to have a structure strong against external impact such as penetration and puncture, and may be appropriately used for a flexible display device due to the flexible characteristic of the resin layer.

In this case, in the first embodiment, the number of laminated resin layers, a thickness thereof, and the like may vary according to a thickness, flexibility, and hardness of the window structure which needs to be applied to the display device.

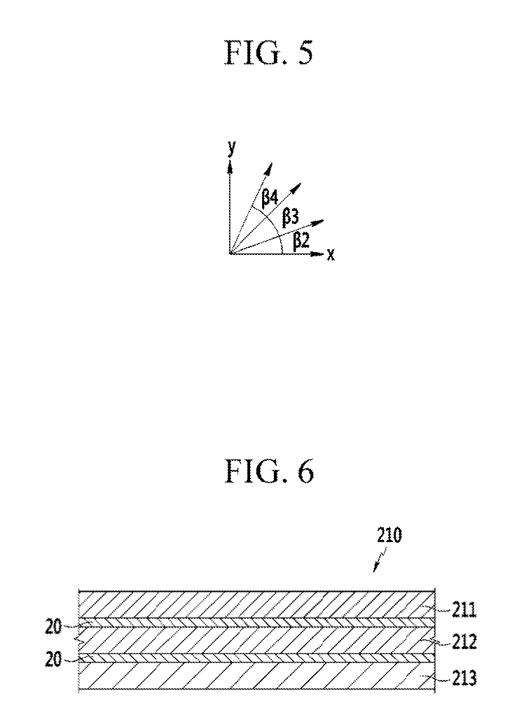

FIG. 4 is a cross-sectional view illustrating a window structure constructed as a second embodiment according to the principles of the present invention. FIG. 5 is a diagram illustrating an angle between grid array angles of adjacent resin layers of the window structure according to the second embodiment.

A window structure 110 according to the second embodiment includes a plurality of resin layers 111, 112, and 113 having fiber structures.

In this case, the window structure 110 according to the second embodiment may be formed to be the same as that of the first embodiment in view of the other configurations, except that angles between a first grid array angle at which a grid structure of the first resin layer 111 is formed and a second grid array angle of the second resin layer 112, a third grid array angle of the third resin layer 113, . . . , and an n-th grid array angle of the n-th resin layer are different from those of the first embodiment.

Hereinafter, when describing the second embodiment, the detailed description for the same configurations as the first embodiment is omitted, and the second embodiment will be described based on differences from the first embodiment.

In the window structure 110 according to the second embodiment, as illustrated in FIG. 5, angles between an n+1-th grid array angle and the grid array angle of the n-th resin layer may be the same as each other.

That is, similarly, in the case where an angle β2 between the first grid array angle and the second grid array angle is 20 degrees, an angle β3 between the second grid array angle and the third grid array angle may be 20 degrees, and an angle β4 between the third grid array angle and the fourth grid array angle may be 20 degrees.

As such, in the case where angles between the grid array angles of the adjacent resin layers in the laminated direction are uniformly formed, since an extended direction of the fiber structure of each resin layer is relatively evenly formed as compared with the case where the angles among the even numbered resin layers and the odd numbered resin layers are alternately the same as each other in the first embodiment, the window structure may have more even hardness throughout in all of the 360 degrees directions.

In this case, the n+1 grid array angle for the grid array angle of the n-th resin layer may vary according to the number of laminated resin layers, a thickness of the resin layer, a property of the fiber structure, and the like.

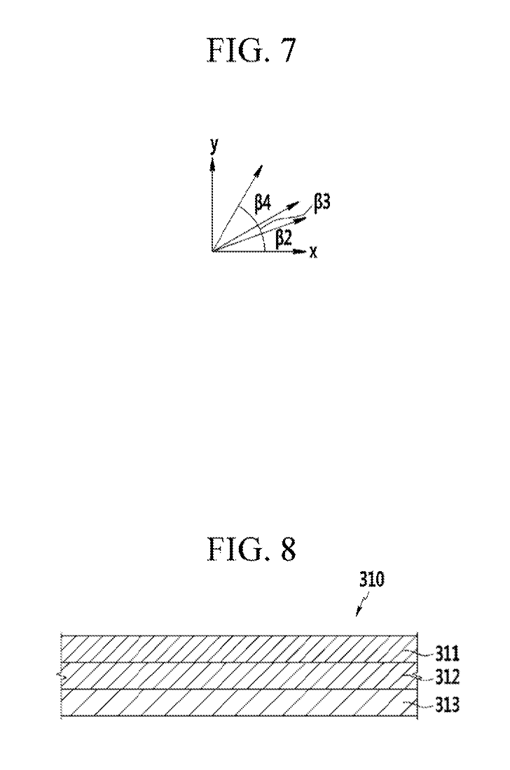

FIG. 6 is a cross-sectional view illustrating a window structure constructed as a third embodiment according to the principles of the present invention. FIG. 7 is a diagram illustrating an angle between grid array angles of adjacent resin layers of the window structure according to the third embodiment.

A window structure 210 according to the third embodiment includes a plurality of resin layers 211, 212, and 213 having fiber structures. In this case, the window structure 210 according to the third embodiment may be formed to be the same as those of the first embodiment and the second embodiment in view of the other configurations, except that an angle β2 between the first grid array angle formed by the grid structure of the first resin layer 211 and the second grid array angle of the second resin layer 212, an angle β3 between the second grid array angle and the third grid array angle of the third resin layer 213, an angle β4 between the third grid array angle and the fourth grid array angle, . . . , and an angle formed by the n-th grid array angle of the n+1-th resin layer are different from those of the first embodiment and the second embodiment.

Hereinafter, when describing the third embodiment, the detailed description for the same configuration as those of the aforementioned embodiments is omitted, and the third embodiment will be described based on differences from the aforementioned embodiments.

In the window structure 210 according to the third embodiment, as shown in FIG. 7, an n+1-th grid array angle is irregularly formed with respect to the grid array angle of the n-th resin layer.

Accordingly, the angle β2 between the first grid array angle and the second grid array angle, the angle β3 between the second grid array angle and the third grid array angle, the angle β4 between the third grid array angle and the fourth grid array angle, . . . , and the angle between the n-th grid array angle and the n+1-th grid array angle are freely formed without regularity.

As such, in the case where the angles between the grid array angles of the adjacent resin layers in the laminated direction are irregularly formed, the window structure may have entirely even hardness without predetermined directionality, which is irregular according to the extended direction of the fiber structure included in the resin layer.

FIG. 8 is a cross-sectional view illustrating a window structure constructed as a fourth embodiment according to the principles of the present invention.

A window structure 310 according to the fourth embodiment is formed to be the same as those of the first to third embodiments in that a plurality of resin layers 311, 312, and 313 including the fiber structures is laminated, but unlike the first to third exemplary embodiments, the plurality of resin layers 311, 312, and 313 does not adhere to each other by an adhesive and may be formed in a single film shape by a film manufacturing method such as extrusion.

In this case, in the window structure 310 according to the fourth embodiment, arrangement of fiber structures formed in the plurality of resin layers 311, 312, and 313 may be the same as the arrangement of the fiber structures described in each of the first to third embodiments, and the detailed description thereof will be omitted.

In the window structure 310 according to the fourth embodiment, the respective resin layers may have the same physical and mechanical characteristics, but may have different physical and mechanical characteristics according to a design.

In addition, in the window structure 310 according to the fourth embodiment, since an adhesive layer is not interposed between the plurality of resin layers 311, 312, and 313, it is possible to prevent deterioration in hardness of the window structure which may occur when the adhesive layer is interposed between the plurality of resin layers 311, 312, and 313.

Further, as compared with the manufacturing method of the first to third embodiments in which the respective resin layers are formed and then laminated by the adhesive, the window structure 310 according to the fourth embodiment is formed in a single film by extrusion, and thus processes of coating a separate adhesive layer and laminating the resin layers are not performed, and as a result, the window structure may be more efficiently produced.

Although not illustrated in the drawings, the aforementioned window structure may be used to form a display device, for example, an organic light emitting display device. The window structure may be formed at a same side of a display unit of the display device. For example, the window structure is disposed on the display unit, through which a user views images displayed by the display device. Alternatively, opposite sides of the display unit may be each covered by a window structure. That is, the display unit is interposed between two window structures.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A window structure for a display device, the window structure comprising a plurality of stacked resin layers, the plurality of resin layers comprising:
a first resin layer including a fiber structure formed in a grid shape by extending a first plurality of fibers in a first direction and by extending a second plurality of fibers in a second direction crossing the first direction; and
a second resin layer including a fiber structure formed in a grid shape by extending a third plurality of fibers in a third direction crossing each of the first and second directions and by extending a fourth plurality of fibers in a fourth direction crossing the third direction.

2. The window structure for a display device of claim 1, wherein an angle between the first direction and the second direction and an angle between the third direction and the fourth direction are equal to each other.

3. The window structure for a display device of claim 1, wherein the first and second directions are perpendicular to each other and the third and fourth directions are perpendicular to each other.

4. The window structure for a display device of claim 1, wherein:
the plurality of stacked resin layers include odd resin layers and even resin layers that are alternatively stacked on the first and second resin layers,
the second resin layer is interposed between the first resin layer and the odd and even resin layers,
each odd resin layer including a fiber structure formed in a grid shape by extending an odd plurality of fibers in the first direction and by extending another odd plurality of fibers in the second direction, and
each even resin layer including a fiber structure formed in a grid shape by extending an even plurality of fibers in the third direction and by extending another even plurality of fibers in the fourth direction.

5. The window structure for a display device of claim 1, wherein:
the plurality of stacked resin layers further include a third through n-th resin layers that are stacked on the first and second resin layers, where n is a natural number and n is equal to or greater than 3,
i-th resin layer includes a fiber structure formed in a grid shape by extending a (2*i−1)th plurality of fibers in a (2*i−1)th direction and by extending a (2*i)th plurality of fibers in a (2*i)th direction crossing the (2*i−1)th direction, where i is a natural number selected from 3 to n, and
an angle between the (2*i−1)th direction and the first direction is i−1 times of an angle between the third direction and the first direction.

6. The window structure for a display device of claim 1, wherein:
the plurality of stacked resin layers further include a third through n-th resin layers that are stacked on the first and second resin layers, wherein n is a natural number and n is equal to or greater than 3,
i-th resin layer includes a fiber structure formed in a grid shape by extending a (2*i−1)th plurality of fibers in a (2*i−1)th direction and by extending a (2*i)th plurality of fibers in a (2*i)th direction crossing the (2*i−1)th direction, where i is a natural number selected from 3 to n, and
an angle between the (2*i−1)th direction and the first direction is randomly selected.

7. The window structure for a display device of claim 1, wherein the fiber structure includes at least one of a transparent glass fiber, a metal fiber, a polymer fiber, an aramid fiber, and an ester fiber.

8. The window structure for a display device of claim 1, wherein the resin layer is made of an elastomer, epoxy, or polymer-based resin.

9. The window structure for a display device of claim 1, wherein adhesive layers for coupling the adjacent resin layers with each other among the plurality of resin layers are interposed among the plurality of resin layers.

10. The window structure for a display device of claim 1, wherein the plurality of resin layers is formed in a single film shape which is formed by extrusion.

11. A display device, comprising:
a display unit displaying an image; and
a window structure including a plurality of stacked resin layers formed at a same side of the display unit, the plurality of resin layers comprising:
a first resin layer including a fiber structure formed in a grid shape by extending a first plurality of fibers in a first direction and by extending a second plurality of fibers in a second direction crossing the first direction; and
a second resin layer including a fiber structure formed in a grid shape by extending a third plurality of fibers in a third direction crossing the first and second directions and by extending a fourth plurality of fibers in a fourth direction crossing the third direction.

12. The display device of claim 11, wherein an angle between the first direction and the second direction and an angle between the third direction and the fourth direction are equal to each other.

13. The display device of claim 11, wherein the first and second directions are perpendicular to each other and the third and fourth directions are perpendicular to each other.

14. The display device of claim of claim 11, wherein:
the plurality of stacked resin layers include odd resin layers and even resin layers that are alternatively stacked on the first and second resin layers,
the second resin layer is interposed between the first resin layer and the odd and even resin layers,
each odd layer including a fiber structure formed in a grid shape by extending an odd plurality of fibers in the first direction and by extending another odd plurality of fibers in the second direction, and
each even layer including a fiber structure formed in a grid shape by extending an even plurality of fibers in the third direction and by extending another even plurality of fibers in the fourth direction.

15. The display device of claim 11, wherein:
the plurality of stacked resin layers further include a third through n-th resin layers that are stacked on the first and second resin layers, where n is a natural number and n is equal to or greater than 3,
i-th resin layer includes a fiber structure formed in a grid shape by extending a (2*i−1)th plurality of fibers in a (2*i−1)th direction and by extending a (2*i)th plurality of fibers in a (2*i)th direction crossing the (2*i−1)th direction, where i is a natural number selected from 3 to n, and
an angle between the (2*i−1)th direction and the first direction is i−1 times of an angle between the third direction and the first direction.

16. The display device of claim 11, wherein:
the plurality of stacked resin layers further includes a third through n-th resin layers that are stacked on the first and second resin layers, wherein n is a natural number and n is equal to or greater than 3,
i-th resin layer includes a fiber structure formed in a grid shape by extending a (2*i−1)th plurality of fibers in a (2*i−1)th direction and by extending a (2*i)th plurality of fibers in a (2*i)th direction crossing the (2*i−1)th direction, where i is a natural number selected from 3 to n, and
an angle between the (2*i−1)th direction and the first direction is randomly selected.

17. The display device of claim 11, wherein the fiber structure includes at least one of a transparent glass fiber, a metal fiber, a polymer fiber, an aramid fiber, and an ester fiber.

18. The display device of claim 11, wherein the resin layer is made of an elastomer, epoxy, or polymer-based resin.

19. The display device of claim 11, wherein adhesive layers for coupling the adjacent resin layers with each other among the plurality of resin layers are interposed among the plurality of resin layers.

20. The display device of claim 11, wherein the plurality of resin layers is formed in a single film shape which is formed by extrusion.
